(19) United States
(12) Patent Application Publication
(10) Pub. No.: US 2025/0030702 A1
(43) Pub. Date: Jan. 23, 2025

(54) APPARATUSES, METHODS, AND COMPUTER PROGRAM PRODUCTS FOR DIGITAL IDENTITY BASED AUTHENTICATION

(71) Applicant: Wells Fargo Bank, N.A., San Francisco, CA (US)

(72) Inventors: Peter BORDOW, Fountain Hills, AZ (US); Jeff J. STAPLETON, O'Fallon, MO (US); Ramesh YARLAGADDA, Charlotte, NC (US)

(21) Appl. No.: 17/389,913

(22) Filed: Jul. 30, 2021

(51) Int. Cl. H04L 29/06

(52) U.S. Cl. CPC H04L 63/123

(57) ABSTRACT

A computer-implemented method, apparatus, and computer program product for digital identity based authentication are provided. An example method includes receiving a request for authentication associated with a first user and determining attributes associated with the first user that include at least one static attribute and at least one dynamic attribute. The method further includes generating an inquiry authentication credential based upon the static attribute and the dynamic attribute and includes querying a digital identity construct database storing one or more previously acquired attributes of the first user. The method includes obtaining a verified authentication credential based upon the previously acquired iterations of the static and dynamic attributes and includes authenticating the first user based upon a comparison between the inquiry authentication credential and the verified authentication credential.

### TECHNOLOGICAL FIELD

Example embodiments of the present disclosure relate generally to authentication and, more particularly, to the use of a dynamic digital identity to provide improved authentication techniques.

### BACKGROUND

Users often interact with a variety of businesses, merchants, financial institutions, and other entities, explicitly or implicitly, as part of their day-to-day lives. In doing so, an assortment of user data is generated that is tied to or representative of the underlying user. Furthermore, user's rely upon the security of the systems used for these interactions in order to keep this user data safe. For example, systems may leverage authentication protocols or credentials in order to ensure that the user with which the system interacts is verified and has access to the features offered by the system

### BRIEF SUMMARY

As described above, authentication may be used in a variety of applications and industries to verify a session or otherwise validate interactions between users or devices. Traditional methods for authentication often rely upon a user to provide a password or other relatively static verifiable element that is used to confirm the identity of the user and generate a secure session with a requested entity (e.g., generate a session identifier that may be based upon the user's password or otherwise). These traditional techniques, however, have become increasingly susceptible to attack as the availability of computing power has increased, enabling exhaustive searching (e.g., Rainbow Tables or equivalent techniques). In this way, a user's session, password, etc. may be compromised simply by virtue of the new technical problems emergent in response to the growing computing resources available today, because perpetrators have a greater ability to breach a user's password or otherwise determine the method by which a session identifier is generated. Furthermore, conventional systems and methods for authenticating a user rely upon stagnant user credentials (e.g., a user inputted password or the like) that may be similarly susceptible to attack and/or require constant vigilance on the part of the user. For example, a user may be traditionally required to not only remember a unique password for use with each entity with which the user interacts but may also be required to diligently protect, update, and/or periodically change these passwords.

To solve these issues and others, example implementations of embodiments of the present disclosure may provide digital identity based authentication techniques that leverage a dynamic and evolving digital identity construct. Embodiments of the present disclosure may determine attributes associated with a first user, in real or substantially real time, in response to a request for authentication. For example, a user device (e.g., mobile phone, wearable device, or the like) and/or an external device (e.g., terminal, computing device, automated teller machine (ATM)) associated with an entity (e.g., business, merchant, financial institution, etc.) may include various sensors (e.g., cameras, accelerometers, gyroscopes, position sensors, etc.) that capture, determine, or otherwise generate user data that includes attributes associated with the user. Given that some attributes of a user are dynamic (e.g., change over time) while others are static (e.g., unaffected by or independent of time), the determined attributes may include at least one dynamic attribute to increase security of the methods described herein. These determined attributes may be used to generate an inquiry authentication credential indicative of the user at the current time (e.g., at the time of the request for authentication). A digital identity construct that operates as an evolving collection of user attributes operates as a dynamically changing but verifiable collection of user attributes against which the inquiry authentication credential may be compared in order to authenticate the user, user device, and/or the like.

In this way, the inventors have identified that the advent of computing resources have created a new opportunity for solutions for authentication which were historically unavailable. In particular, the embodiments herein may operate to address several technical challenges including providing a mechanism for real time authentication based upon evolving user attributes. Said differently, some embodiments described herein may detect the available user attribute data (e.g., as defined by applicable sensing devices or the like) and modify attribute selection based upon the same. Furthermore, these embodiments may provide a mechanism for varying attribute security based upon the assurance associated with a particular interaction. For example, the request for authentication received by the system may determine a variable assurance level associated with the interaction (e.g., an increased assurance associated with large value transactions, an increased assurance associated with particularly vulnerable or sensitive user data, etc.) and modify the amount or type of user attributes selected.

Systems, apparatuses, methods, and computer program products are disclosed herein for digital identity based authentication. In one embodiment, with reference to the claimed method, a method for digital identity based authentication is provided. The method may include receiving a request for authentication associated with a first user and determining attributes associated with the first user. The attributes may include at least one static attribute, wherein static that remain constant over time and at least one dynamic attribute that varies over time (e.g., is capable of change over time). The method may include generating an inquiry authentication credential based upon the at least one static attribute and the at least one dynamic attribute determined for the first user and querying a digital identity construct database storing one or more previously acquired attributes of the first user. The digital identity construct database may include at least one previously acquired iteration of the at least one determined static attribute and at least one previously acquired iteration of the at least one determined dynamic attribute of the first user. The method may include obtaining a verified authentication credential based upon the previously acquired iteration of the at least one determined static attribute of the first user and the previously acquired iteration of the at least one determined dynamic attribute of the first user and authenticating the first user based upon a comparison between the inquiry authentication credential and the verified authentication credential.

In some embodiments, the request for authentication further may include an instruction to generate a session identifier from a first user device associated with the first user. In such an embodiment, the method may further include generating the session identifier based upon the verified authentication credential and transmitting the session identifier to the first user device.

In some embodiments, the method may further include modifying the previously acquired iteration of the at least one dynamic attribute of the first user stored by the digital identity construct database based upon the at least one determined dynamic attribute.

In some embodiments, determining attributes associated with the first user may further include receiving sensor data from a first user device associated with the first user and determining one of the at least one static attribute or the at least one dynamic attribute of the first user based upon the sensor data.

In some embodiments, determining attributes associated with the first user may further include determining an assurance requirement associated with the request for authentication and modifying one or more of an amount of attributes associated with the first user or a type of attributes associated with the first user.

In some embodiments, authenticating the first user may further include determining a variability between the inquiry authentication credential and the verified authentication credential, comparing the variability with a variability threshold, and authenticating the first user in an instance in which the determined variability satisfies the variability threshold.

In some further embodiments, authenticating the first user may further include comparing the variability with a modification threshold and modifying the previously acquired iteration of the at least one dynamic attribute of the first user stored by the digital identity construct database in an instance in which the variability satisfies the modification threshold. Furthermore, a user device may capture new attributes of the user so as to update the digital identity construct. In doing so, new attributes or new iterations of previously-acquired attributes may also be used to improve the quality of user attributes or remove/replace attributes that are no longer applicable to the user so as to ensure that credentials generated based upon these attributes are accurate.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for digital identity based authentication, in accordance with some example embodiments described herein.

FIG. 4 illustrates an example flowchart for session authentication based on digital identity, in accordance with some example embodiments described herein.

FIG. 5 illustrates an example flowchart for credential variability determinations, in accordance with some example embodiments described herein.

FIG. 6 illustrates a visual representation of an example digital identity construct configuration, in accordance with some example embodiments described herein.

### DETAILED DESCRIPTION

Some embodiments of the present disclosure will now be described more fully hereinafter with reference to the accompanying drawings, in which some, but not all embodiments of the disclosure are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout. As used herein, the description may refer to an identity server as an example “apparatus.” However, elements of the apparatus described herein may be equally applicable to the claimed method and computer program product. Thus, use of any such terms should not be taken to limit the spirit and scope of embodiments of the present disclosure.

### Definition of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to, and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used herein to mean “serving as an example, instance, or illustration.” Any implementation described herein as “example” is not necessarily to be construed as preferred or advantageous over other implementations.

As used herein, the terms “user device,” “first user device,” “mobile device,” “electronic device” and the like refer to computer hardware that is configured (either physically or by the execution of software) to access one or more services made available by the identity server (e.g., apparatus or computing device of the present disclosure) and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with chip of other electronic device that is configured to communicate with the external device via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the identity server 200 or other computing device via a network.

The “user device” “first user device,” etc. may, in some embodiments define, include, access, or otherwise leverage one or more sensing devices or sensors. For example, the user device may include one or more cameras, infrared (IR) sensors, scanning devices, imagers, accelerometers, gyroscopes, positional sensors, heartrate sensors, temperature sensors, pressure sensors, positional sensors, and/or the like configured to generate user data associated with or indicative of the first user. The one or more sensing devices or sensors may be configured to generate user data associated with user attributes (e.g., dynamic or static) as defined herein. The present disclosure contemplates that any example user device may include any number of sensing devices without limitation.

As used herein, the term “external device” refers to any object, device, or system which may be in network communication with the first user device or identity server. For example, an external device may be an external server or computing device (e.g., associated with a corporation, banking entity, or other 3^{rd} party) that may request, receive, and/or provide data to or from one of the devices described above. By way of a more particular example, an external device may include a server of a bank, online vendor, ATM, or the like configured to be located in secure communication with the first user device via an authenticated session (e.g., via the authentication techniques described herein).

The “external device” may, in some embodiments, also define include, access, or otherwise leverage one or more sensing devices or sensors. For example, the external device may include one or more cameras, infrared (IR) sensors, scanning devices, imagers, accelerometers, gyroscopes, positional sensors, heartrate sensors, temperature sensors, pressure sensors, positional sensors, and/or the like configured to generate user data associated with or indicative of the first user. The one or more sensing devices or sensors may be configured to generate user data associated with user attributes (e.g., dynamic or static) as defined herein. The present disclosure contemplates that any example external device may include any number of sensing devices without limitation.

As used herein, the terms “digital identity construct” and “digital identity construct database” refer to a data structure or repository for storing user attributes. The digital identity construct database may, for example, include a plurality of static attributes and dynamic attributes. As such, “static” attributes may refer to data entries associated with user attributes that may remain constant over time. By way of example, a static attribute may include dates, locations, addresses, and/or the like indicative of events (e.g., birthdays, first car purchase, most recent mailing addresses, or the like) that do not change. Alternatively, “dynamic” attributes may refer to data entries associated with user attributes that may vary over time. By way of example, a dynamic data attribute may include biometric features (e.g., age, weight, height, hair color, etc.), current location data, and/or the like that are capable of changing as, for example, a user ages, moves, etc. The present disclosure contemplates that the digital identity construct may include any number of user attributes associated with any number of respective users and may operate to, in some embodiments, store substantially all identifying data attributes, events, or the like associated with a particular user. Said differently, the present disclosure contemplates that the digital identity construct database may store any feature, data entry, element, data object, etc. associated with a user without limitation so as to form a substantially complete digital representation of the user's identity. For example, the digital identity construct and digital identity database may encompass, include, or otherwise access an identity system or identity databank, such as those described in U.S. patent application Ser. No. 16/268,288.

The digital identity construct database may be, for example, initially populated or otherwise supplied with user data as part of an initial set up procedure. For example, a first user may supply information (e.g., static or dynamic) about the user as part of an account set up procedure. Additionally or alternatively, the digital identity construct may be populated, updated, modified, or the like over time to provide an evolving repository of user attributes. For example, one or more static user attributes may be added to the digital identity construct database over time (e.g., new biometric data entries, new locations, new addresses, new financial transactions, etc.) and one or more dynamic user attributes may be updated or modified over time (e.g., current location, current job, new height, new weight, new hair color, etc.). In some instances, user attributes may be added or updated in the digital identity construct database in response to actions on the part of the user, such as input by the user in response to a request. In other embodiments, attributes may be added or updated in the digital identity construct automatically or otherwise without affirmative action on the part of the associated user. By way of example, a user may interact with an automated teller machine (ATM) and may input user attributes associated with the user (e.g., a request for an updated address, phone number, etc.). The ATM (e.g., external device) may include, for example, one or more sensors (e.g., cameras, scanners, scales, microphones, or the like) configured to determine user attributes (e.g., hair color, weight, etc.) and may update the digital identity construct accordingly. The present disclosure contemplates that any mechanism for supplying user attributes to the digital identity construct (e.g., social media scraping, location data monitoring, transaction history analysis, data processing, etc.) may be used without limitation.

The International Organization for Standardization (ISO) standard ISO/IEC 24760-1:2011—Security techniques—A framework for identity management—Part 1: Terminology and Concepts, defines identity as a set of attributes related to an entity. As such, the digital identity construct and digital identity construct database described herein may be configured such that digital identity is information (e.g., attributes) that may be used to represent an entity. Thus the digital identity construct that includes dynamic user attributes is a set of attributes that may change over time such that the most current version of user attributes be used for generating user authentication credentials for online authentication while the most recent user attributes (e.g., the most recent iteration of a dynamic user attribute) may be used to generate use authentication credentials for offline authentication.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

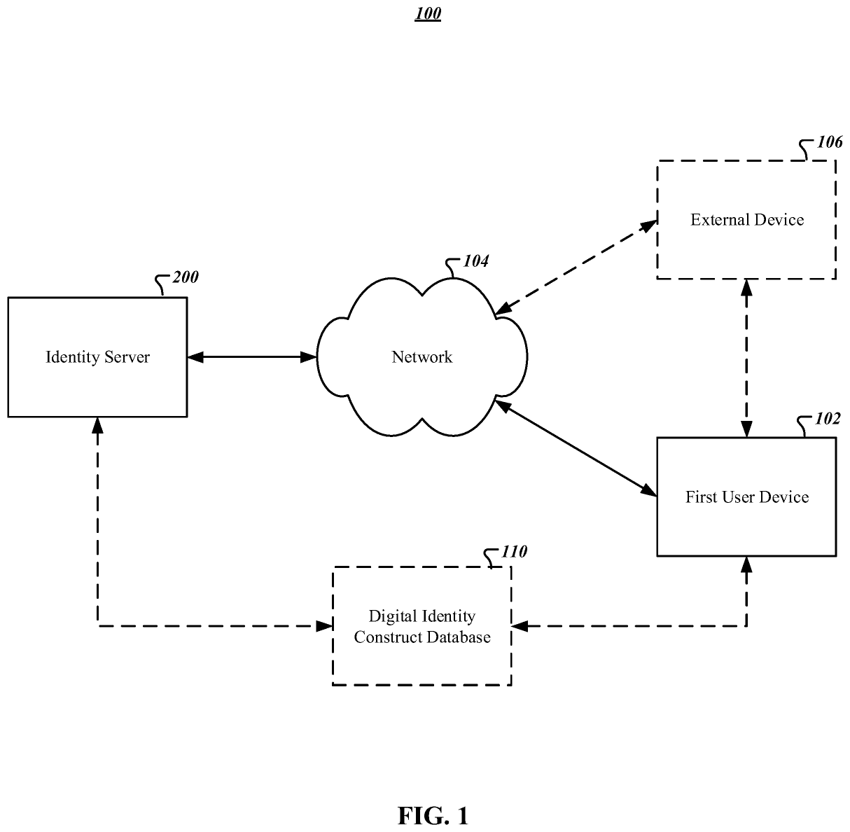

With reference to FIG. 1, an example system 100 is illustrated with an apparatus (e.g., an identity server 200) communicably connected via a network 104 to a first user device 102 and, in some embodiments, an external device 106. The example system 100 may also include an digital identity construct database 110 that may be hosted by the identity server 200 or otherwise hosted by devices in communication with the identity server 200.

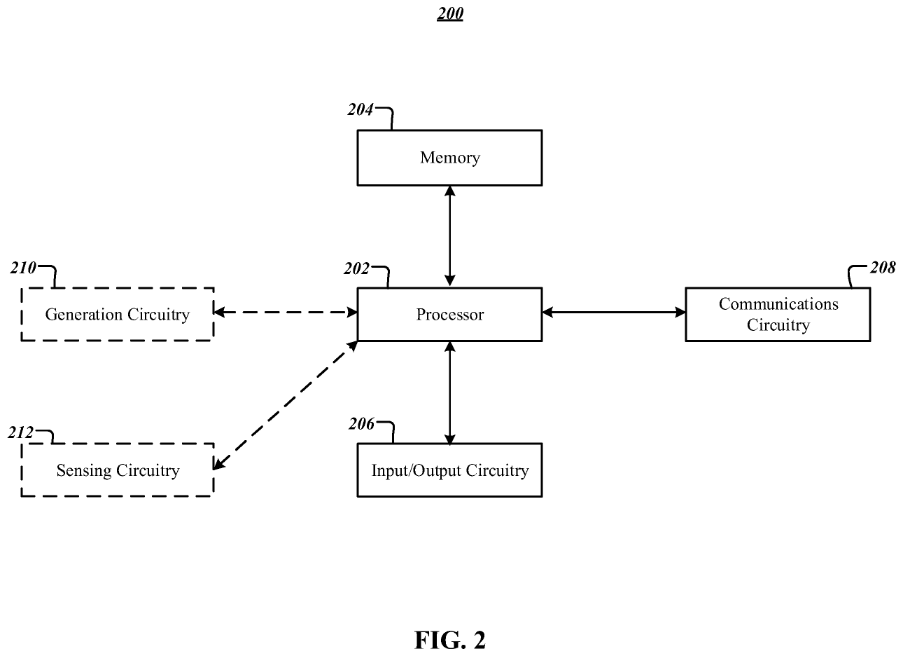

The identity server 200 may include circuitry, networked processors, or the like configured to perform some or all of the apparatus-based (e.g., identity server-based) processes described herein, and may be any suitable network server and/or other type of processing device. In this regard, identity server 200 may be embodied by any of a variety of devices. For example, the identity server 200 may be configured to receive input data (e.g., user attribute data, sensor data, sensing data, etc.) and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs, but will nevertheless include at least the components illustrated in FIG. 2 and described in connection therewith. In some embodiments, the identity server 200 may be located remotely from the first user device 102, external device 106, and/or digital identity construct database 110, although in other embodiments, the identity server 200 may comprise the first user device 102, external device 106, and/or digital identity construct database 110. The identity server 200 may, in some embodiments, comprise several servers or computing devices performing interconnected and/or distributed functions. Despite the many arrangements contemplated herein, the identity server 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The first user device 102 may be associated with a first user and may be configured to generate and/or access user attribute data associated with the first user. Although a single user device associated with a corresponding user is shown, the example system 100 may include any number of user devices that may be associated with various users. The first user device 102 may be a cellular telephone (e.g., a smartphone and/or other type of mobile telephone), laptop, tablet, electronic reader, e-book device, media device, wearable, smart glasses, smartwatch, ATM, mobile device, any combination of the above, or any device by which the first user may access the identity server 200, the digital identity construct database 110, or the like. In some embodiments, the first user device 102 may be configured to request authentication (e.g., from the identity server 200). The first user device 102 may also allow a user to provide input (e.g., by way of a biometric scan, actionable notification, or the like) via sensing devices or sensors, which may be conveyed to the identity server 200 via the network 104 as attribute data. Use data or attribute data may be, as described above, generated via one or more input devices, sensing devices, or sensors, including, without limitation, a touchscreen, microphone, camera, optical scanner, fingerprint reader, and/or motion sensor device (e.g., an accelerometer, gyroscope, etc.).

The external device 106, as defined above, may be associated with any entity that is not associated with the first user device 102. By way of a more particular example, the external device 106 may include a server of a bank, online vendor, or other 3^{rd}-party configured to be in secure communication with the first user device 102 via the network 104 (e.g., an authenticated session). Although shown as a single external device 106, the system 100 may include any number of external devices. In some embodiments, the external device 106 may be configured to request authentication (e.g., from the identity server 200), such as to establish a secure session with the first user device 102. The external device 106 may also allow a user to provide input (e.g., by way of a biometric scan, actionable notification, or the like) which may be conveyed to the identity server 200 via the network 104 as attribute data. Attribute data may be generated via one or more input devices including, without limitation, a touchscreen, microphone, cameras, infrared (IR) sensors, scanning devices, imagers, accelerometers, gyroscopes, positional sensors, heartrate sensors, temperature sensors, pressure sensors, positional sensors, and/or the like, optical scanner, fingerprint reader, and/or the like.

The digital identity construct database 110 may be stored by any suitable storage device configured to store some or all of the information described herein (e.g., memory 204 of the identity server 200 or a separate memory system separate from the identity server 200, such as one or more database systems, backend data servers, network databases, cloud storage devices, or the like provided by an external device 106 (e.g., a banking entity or 3^{rd} party provider) or the first user device 102). The digital identity construct database 110 may comprise data received from the identity server 200 (e.g., via a memory 204 and/or processor(s) 202) or the first user device 102, and the corresponding storage device may thus store this data. To avoid unnecessarily overcomplicating the disclosure, the digital identity construct database 110 is shown and described as a separate database, despite the fact that they may each be hosted by any number of specific physical devices, together or separately.

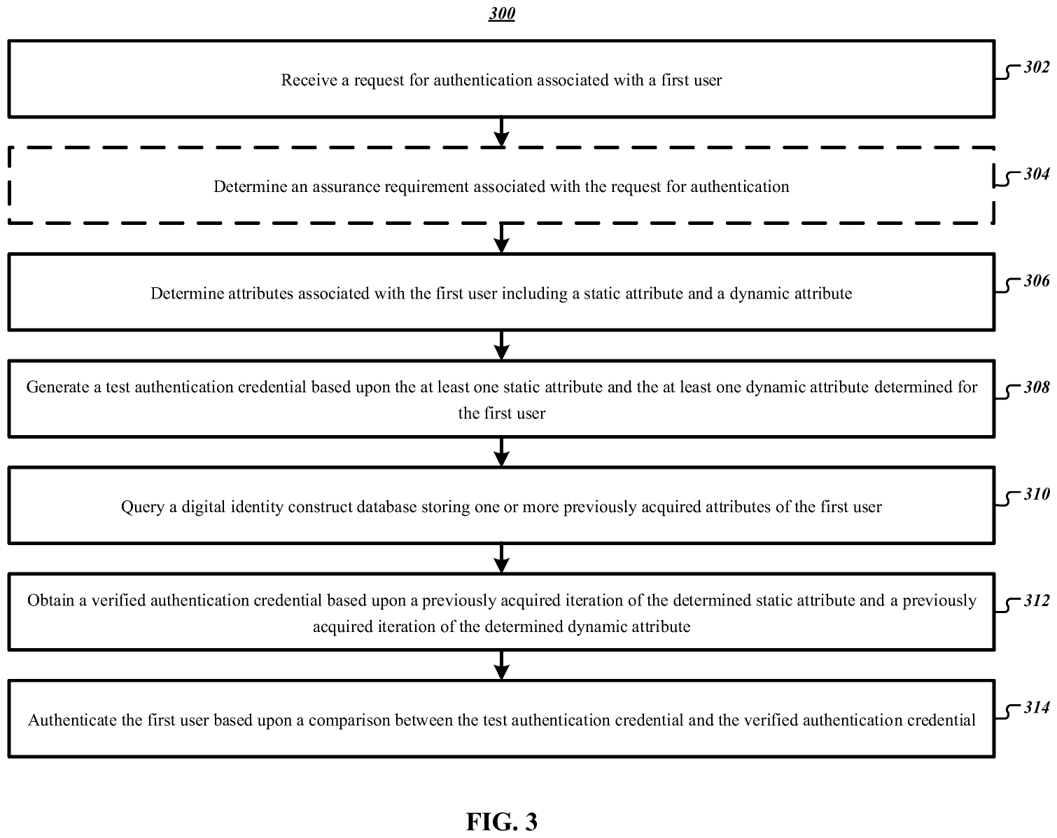

As illustrated in FIG. 2, the identity server 200 may include a processor 202, a memory 204, input/output circuitry 206, and communications circuitry 208. Moreover, identity server 200 may include generation circuitry 210 and/or sensing circuitry 212. The identity server 200 may be configured to execute the operations described below in connection with FIGS. 3-5. Although components 202-212 are described in some cases using functional language, it should be understood that the particular implementations necessarily include the use of particular hardware. It should also be understood that certain of these components 202-212 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the identity server 200 may be housed within one or more of the first user device 102 or the external device 106. As indicated previously, it will be understood in this regard that some of the components described in connection with the identity server 200 may be housed within one of these devices, while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the identity server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the identity server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the identity server to carry out various functions in accordance with example embodiments of the present disclosure.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the identity server, and/or remote or “cloud” processors.

In an example embodiment, the processor 202 may be configured to execute instructions stored in the memory 204 or otherwise accessible to the processor 202. Alternatively or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

The identity server 200 further includes input/output circuitry 206 that may, in turn, be in communication with processor 202 to provide output to a user and to receive input from a user, user device, or another source (e.g., so as receive user attribute data or sensor data). In this regard, the input/output circuitry 206 may comprise a display that may be manipulated by a mobile application. In some embodiments, the input/output circuitry 206 may also include additional functionality such as a keyboard, a mouse, a joystick, a touch screen, touch areas, soft keys, a microphone, a speaker, or other input/output mechanisms. The processor 202 may be configured to control one or more functions of a display through computer program instructions (e.g., software and/or firmware) stored on a memory accessible to the processor (e.g., memory 204, and/or the like), so as receive user attribute data and/or sensor data.

The communications circuitry 208 may be any means such as a device or circuitry embodied in either hardware or a combination of hardware and software that is configured to receive and/or transmit data from/to a network and/or any other device, circuitry, or module in communication with the identity server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s). These signals may be transmitted by the identity server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

Generation circuitry 210 includes hardware components designed to generate inquiry authentication credentials and obtain verified authentication credentials. The generation circuitry 210 may further include hardware components configured to employ one or more hash functions, randomization functions, binarizing operations, or other techniques configured to convert non-numerical elements into associated numerical values. Generation circuitry 210 may utilize processing circuitry, such as the processor 202, to perform its corresponding operations, and may utilize memory 204 to store collected information.

Sensing circuitry 212 includes hardware components designed to either generate sensor data, such an embodiments in which the user device 102 comprises the identity server 200, or to analyze sensor data, such as data generated by one or more sensing devices of the first user device 102. For example, sensing circuitry 212 may include hardware components configured to perform image processing. Sensing circuitry 212 may utilize processing circuitry, such as the processor 202, to perform its corresponding operations, and may utilize memory 204 to store collected information.

It should also be appreciated that, in some embodiments, the generation circuitry 210 and/or the sensing circuitry 212 may include a separate processor, specially configured field programmable gate array (FPGA), or application specific interface circuit (ASIC) to perform its corresponding functions.

In addition, computer program instructions and/or other type of code may be loaded onto a computer, processor or other programmable identity server's circuitry to produce a machine, such that the computer, processor other programmable circuitry that execute the code on the machine create the means for implementing the various functions, including those described in connection with the components of identity server 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Digital Identity Based Authentication

FIG. 3 illustrates a flowchart containing a series of operations for digital identity based authentication. The operations illustrated in FIG. 3 may, for example, be performed by, with the assistance of, and/or under the control of an apparatus (e.g., identity server 200), as described above. In this regard, performance of the operations may invoke one or more of processor 202, memory 204, input/output circuitry 206, communications circuitry 208, generation circuitry 210, and/or sensing circuitry 212.

As shown in operation 302, the apparatus (e.g., identity server 200) includes means, such as input/output circuitry 206, communications circuitry 208, or the like, for receiving a request for authentication associated with a first user. In some example embodiments, the communications circuitry 208 may receive a request for authentication from a first user device 102 and/or external device 106. By way of example, the first user device 102 may request an authorized and authenticated session with the external device 106 and may request that the session be authenticated by the identity server 200. Similarly, in some embodiments, the first user device 102 may receive a request for a session from an external device 106, and may request that the identity server 200 authorize and authenticate the session. In some other embodiments, the input/output circuitry 206 of the identity server 200 may receive a request (e.g., via a direct user input or automatically) for authentication (e.g., session or interaction) so as to interact with the first user device 102 and/or the external device 106, such as in an instance in which the identity server 200 requires an authenticated session to transmit or receive user data (e.g., to modify the digital identity construct database 110 or otherwise. Alternatively, however, the input/output circuitry 206 may receive the request for authentication from direct user interaction with the identity server 200, such as instances in which the first user device 102 comprises the identity server 200 in whole or in part.

In some embodiments, as shown in operation 304, the apparatus (e.g., identity server 200) includes means, such the processor 202 or the like, for determining an assurance requirement associated with the request for authentication. As described above, users may engage in a variety of interactions, transactions, or the like, each of which may be associated with a different risk. For example, a minor cash withdrawal from an ATM may be less risky than a large wire transfer. As such, the assurance requirement determined at operation 304 may be used to, for example, modify one or more of an amount of attributes associated with the first user or a type of attributes associated with the first user. For example, the determined assurance requirement may operate to, in an instance in which an increased assurance is required (e.g., a large transaction), increase the number of attributes determined for the first user (e.g., a requirement of a plurality of static attributes and a plurality of dynamic attributes as described hereafter). By way of an additional example, particular user attributes may be associated with an increased security (e.g., due the difficulty associated with determining or reproducing these attributes) such that selection of one or more of these attributes may operate to provide an increased assurance. For example, the current length of a user's hair may be difficult or impossible to reproduce without real time user image data (e.g., from sensing devices of the first user device 102, the external device 106, etc.), such that use of this attribute in generating authentication credentials provides increased security.

Similarly, each user data entry and/or user attribute may also be associated with a particular vulnerability or sensitivity. For example, a user attribute associated with a user's hair color may be less vulnerable or sensitive relative to a user attribute associated with the user's social security number. Furthermore, in some instances, the first user may select various user attributes, from amongst the digital identity construct database 110 or otherwise, to avoid in authentication operations. For example, a particular user may to limit access to the user's address and, as such, may provide instructions to the identity server 200 (e.g., via set up procedure or otherwise) to limit access to the user's address. The present disclosure contemplates that any number of user attributes and/or any type of user attributes may be used by the identity server 200 based upon the intended application of the server 200.

Thereafter, as shown in operation 306, the apparatus (e.g., identity server 200) includes means, such the processor 202 or the like, for determining attributes associated with the first user. As described above, the attributes may include at least one static attribute that remains constant over time and at least one dynamic attribute that varies over time. Said differently, the determination at operation 306 may require a dynamic attribute in ultimately authenticating the first user as described herein in order to provide increased security associated with authenticating the interaction. In some embodiments, the determination of attributes (e.g., the number of attributes and/or type of attributes) may be based upon the available mechanisms of capturing user data and user attributes associated with the first user device 102 and/or the external device 106. By way of a nonlimiting example, the request at operation 302 may be received from the first user device 102 (e.g., a user's mobile phone) or from an external device 106 (e.g., an ATM). Each of these devices may, in some instances, include a camera (e.g., sensing device) configured to capture one or more images of the first user at the time of the request and a keypad configured to receive one or more user inputs. As such, the attributes determined at operation 306 may be related to the data that is generated by, for example, the camera and the keypad.

By way of continued example, the identity server 200 may determine the at least one static attribute based upon an input by the first user (e.g., via the first user device 102 or the external device 106). By way of a particular example, the user may be prompted to input his or her first home address for use as the determined static attribute. Similarly, the identity server 200 may determine the at least one dynamic attribute based upon one or more captured images of the first user at the time of the request for authentication. By way of a particular example, a camera (e.g., sensing device or sensor) may generate sensor data associated with the first user. The sensing circuitry 212 or the like may employ one or more image processing techniques to determine the current length of the first user's hair. Although described herein with reference to user attributes associated with a user's first address and current hair length, the present disclosure contemplates that the determined user attributes may include any biometric feature, attribute, location, and/or the like associated with the user without limitation.

Thereafter, as shown in operation 308, the apparatus (e.g., identity server 200) includes means, such as processor 202, generation circuitry 210, or the like, for generating an inquiry authentication credential based upon the at least one static attribute and the at least one dynamic attribute determined for the first user. In instances in which the user attribute (e.g., static or dynamic) is associated with a location (e.g., global positioning system (GPS) coordinates or the like), a date (e.g., birthdate, date of first car purchase, etc.) or numerical biometric feature (e.g., weight, height, etc.) or the like, the generation of the portion of the inquiry authentication credential for this attribute may refer to the numerical value associated with the attribute. In other embodiments in which the user attribute is not associated with a numerical value (e.g., a user's hair color, type of car owned, city of current location, etc.), the identity server 200 may employ one or more hash functions, randomization functions, binarizing operations, or other techniques configured to convert non-numerical elements into associated numerical values. The generation of the inquiry authentication credential, the identity server 200 may, for example, perform any mathematical transformation based on the numerical values of the determined attributes. For example, the mathematical operation, in some embodiments, may comprise a multiplication of the value associated with the determined static attribute with the value associated with the determined dynamic attribute.

The present disclosure contemplates that any number of mathematical operations and combinations of mathematical operations (e.g., multiplication, addition, subtraction, division, exponential functions, logarithmic functions, etc.) may be used to generate the inquiry authentication credential at operation 308 such that the generated inquiry authentication credential is of near-infinite scope and degree. Furthermore, the present disclosure contemplates that the numerical values obtained from the static attribute and the dynamic attribute (e.g., or a plurality of the same) may, based upon the size of these numerical values, operate to increase the assurance associated with the inquiry authentication credential. For example, increasing the number of selected attributes and/or the values of these attributes (e.g., GPS coordinates or the like) operates to substantially increase the complexity of the generated inquiry authentication credential.

In some example embodiments, such as instances in which the identity server accesses a plurality of static attributes and a plurality of dynamic attributes, the determination of the attributes at operation 306 may include implementing a random or pseudo-random selection protocol that identifies at least one static attribute and at least one dynamic attribute. By way of example, in some embodiments, once a dynamic or static attribute is selected, a selection frequency for each user attribute may be monitored such that the likelihood that an unselected attribute is selected on subsequent determinations at operation 306 is increased until the unselected attributed is used. Although an example frequency calculation procedure is described herein, the present disclosure contemplates that any pseudo-random number generation algorithm (e.g., a middle-square method, mersenne twister, inversive congruential generator, lagged Fibonacci generator, linear feedback shift register or the like) may additionally or alternatively be used to pseudo-randomly determine the at least one static attribute and the at least one dynamic attribute without departing from the scope of the disclosure.

Thereafter, in operation 310 the apparatus (e.g., identity server 200) may further include means, such as the input/output circuitry 206, communications circuitry 208, or the like for querying a digital identity construct database storing one or more previously acquired attributes of the first user. The digital identity construct database 110 may comprise at least one previously acquired iteration of the at least one determined static attribute and at least one previously acquired iteration of the at least one determined dynamic attribute of the first user. As described herein, the identity server 200 may operate to authenticate a user, in real-time or substantially real time. As such, the identity server 200 may query a digital identity construct database 110 that includes one or more previously acquired attributes of the first user in order to generate a verified authentication credential as described hereafter. As such, the at least one static attribute and the at least one dynamic attribute determined at operation 306 may match the type of attributes retrieved from the digital identity construct database 100.

Thereafter, as shown in operation 312, the apparatus (e.g., identity server 200) includes means, such as processor 202, generation circuitry 210, or the like, for obtaining a verified authentication credential based upon the previously acquired iteration of the determined static attribute and the previously acquired iteration of the determined dynamic attribute. Similar to operation 308, in instances in which the user attribute (e.g., static or dynamic) is associated with a location (e.g., global positioning system (GPS) coordinates or the like), a date (e.g., birthdate, date of first car purchase, etc.) or numerical biometric feature (e.g., weight, height, etc.) or the like, the generation of the verified authentication credential for this attribute may refer to the numerical value associated with the attribute. In other embodiments in which the user attribute is not associated with a numerical value (e.g., a user's hair color, type of car owned, city of current location, etc.), the identity server 200 may employ one or more hash functions, randomization functions, binarizing operations, or other techniques configured to convert non-numerical elements into associated numerical values. In the generation of the verified authentication credential, the identity server 200 may, for example, perform any mathematical transformation based on the numerical values of the previous iterations of the determined attributes. For example, the mathematical operation, in some embodiments, may comprise a multiplication of the value associated with the previous iteration of the determined static attribute with the value associated with the pervious iteration of the determined dynamic attribute. In some embodiments, the previous iterations of the static and dynamic attributes, and combinations thereof, may be stored by the digital identity construct database as authentication credentials, such that the querying of the digital identity construct database at operation 310 inherently obtains the verified authentication credential.

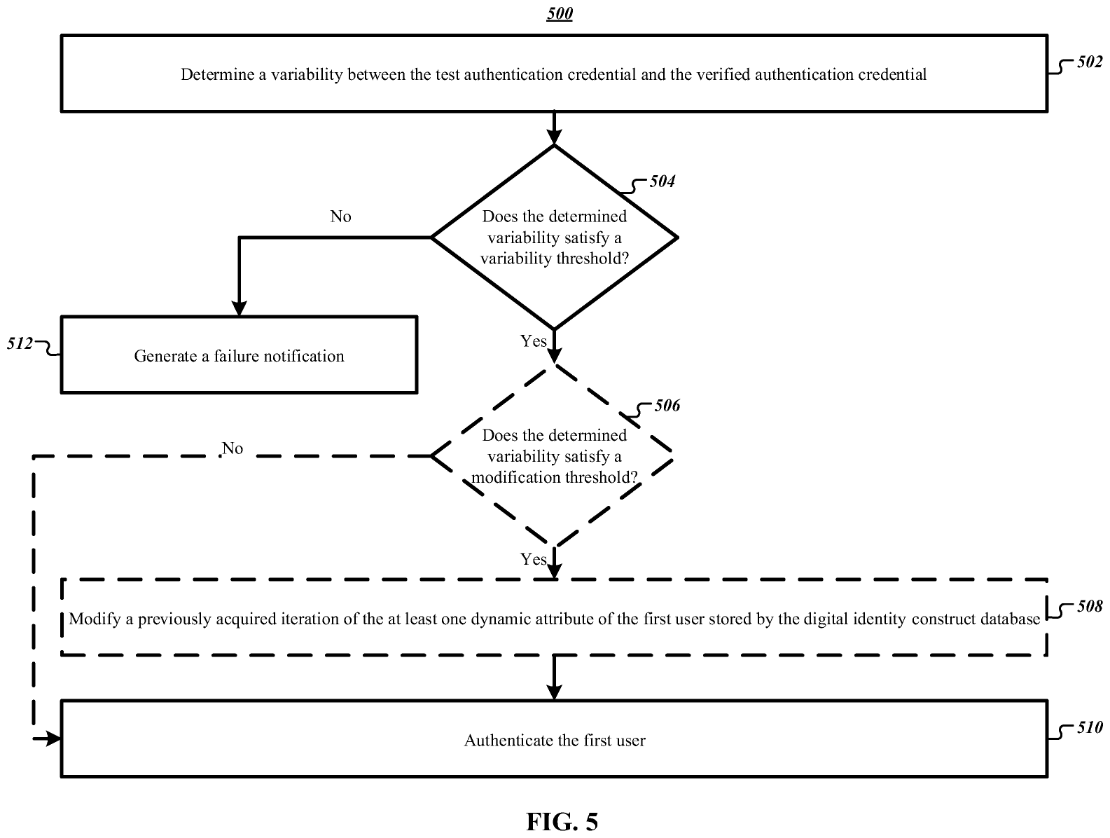

Thereafter, in operation 314, the apparatus (e.g., identity server 200) may further include means, such as the processor 202, generation circuitry 210, or the like for authenticating the first user based upon a comparison between the inquiry authentication credential and the verified authentication credential. As described hereafter with reference to FIG. 5, the identity server 200 may operate to determine a variance or variability, if any, between the inquiry authentication credential and the verified authentication credential. As would be evident by the nature of the dynamic user attribute, the numerical value associated with the dynamic user attribute used in generating the inquiry authentication credential may vary (e.g., a change in the user's hair length, weight, age, etc.). This variance or variability may, as described hereafter, define a numerical representation of the difference between the inquiry authentication credential and the verified authentication credential (e.g., a confidence parameter, an absolute value of the difference, etc.). In an instance in which this determined variance satisfies an associated variance threshold (e.g., a required similarity between authentication credentials), the identity server 200 may authenticate the first user. The present disclosure contemplates that, given that the attributes of the user may be dynamic, the identity server 200 may employ one or more neural networks, machine learning techniques, feedback loops, etc. in order to predict or otherwise determine variance associated with, for example, a dynamic user attribute.

Following authentication of the user as described with reference to FIG. 3, one or more authorization operations may occur so as to authorize one or more actions for the first user and/or first user device 102. Said differently, the authentication operations of FIG. 3 may refer to authenticating the user (e.g., confirming the identity of the first user) while subsequent authorization may occur for the authenticated first user. For example, the identity server 200 may be configured to provide physical access to one or more locations, system access, network, access, application access, or the like based upon the intended operation of the server 200.

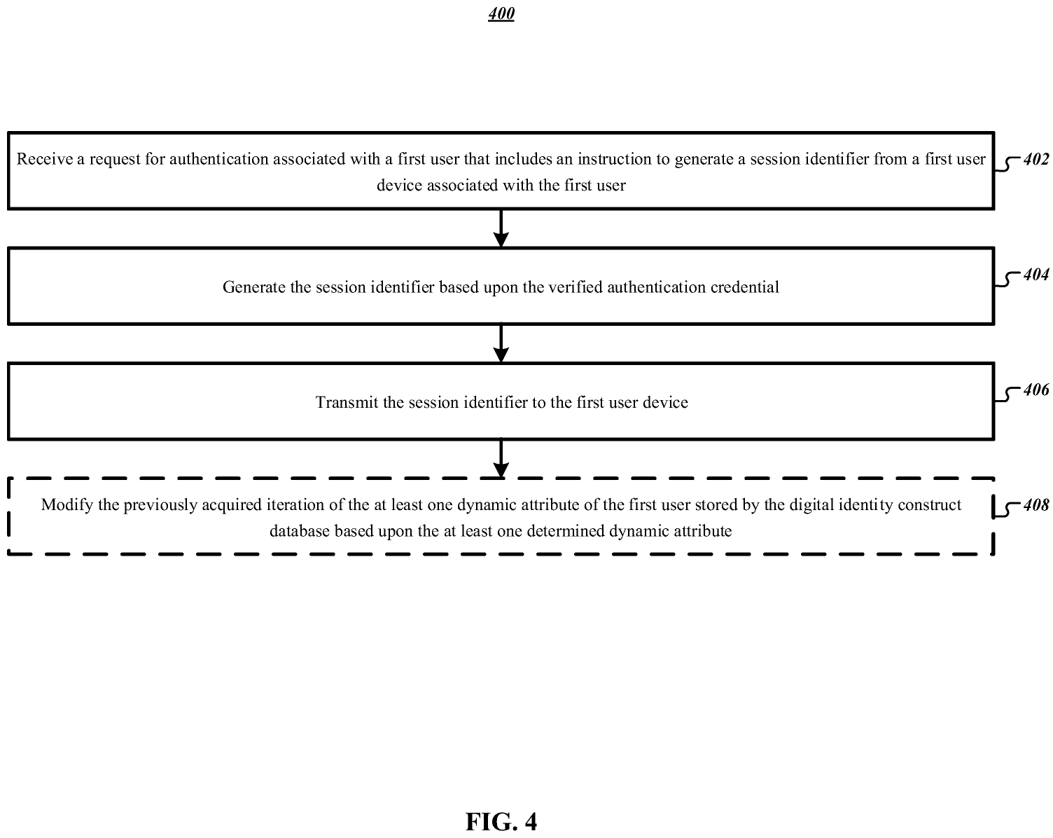

Turning next to FIG. 4, a flowchart is shown that describes generation of a session identifier based on the verified authentication credential of FIG. 3. The operations illustrated in FIG. 4 may, for example, be performed by, with the assistance of, and/or under the control of an apparatus (e.g., identity server 200), as described above. In this regard, performance of the operations may invoke one or more of processor 202, memory 204, input/output circuitry 206, communications circuitry 208, generation circuitry 210, and/or sensing circuitry 212.

In operation 402, the apparatus (e.g., identity server 200) may further include means, such as the input/output circuitry 206, communications circuitry 208, or the like for receiving a request for authentication associated with a first user that includes an instruction to generate a session identifier from a first user device associated with the first user. As described above, in some embodiments, the first user device 102 may transmit an instruction to the identity server 200 to request authentication. By way of example, a first user device 102 may be communicably connected to an external device 106 (e.g., an online vendor or banking entity) and may, due to the circumstances surrounding the connection (e.g., purchasing an item, performing a wire transfer, or the like), request an authenticated session that requires a session identifier. This request may be transmitted by the first user device 102 as a results of a user input, but, in many cases, the first user device 102 may automatically transmit a request for an authenticated session and associated session identifier (e.g., an initial connection to the online vendor's website, logging into an online bank account, etc.).

With reference to operation 404, the apparatus (e.g., identity server 200) includes means, such as processor 202, memory 204, generation circuitry 210, or the like, for generating a session identifier based upon the verified authentication credential (e.g., obtained by the operations of FIG. 3). In some embodiments, the session identifier comprises the authentication credentials of the user. In such an embodiment, the verified authentication credential (e.g., as obtained by the operations of FIG. 3) may be transmitted by the identity server 200 to one or more of the first user device 102 or the external device 106. In other embodiments, the verified authentication credential obtained by the operations of FIG. 3 may be used as a data seed for use in further authentication operations. For example, the verified authentication credential may be used to seed a linear congruential generator (e.g., or other equivalent pseudo-random number generation algorithms) to further complicate the process required for a perpetrator to determine the session identifier. Although described in reference to a liner congruential generator, the present disclosure contemplates that any other pseudo-random number generation algorithm (e.g., a middle-square method, mersenne twister, inversive congruential generator, lagged Fibonacci generator, linear feedback shift register or the like) may be used without departing from the scope of the disclosure.

Thereafter, as shown in operation 406, the apparatus (e.g., identity server 200) includes means, such as communications circuitry 208 or the like, for transmitting the session identifier to the first user device 102. As described above with reference to authenticating a session, the communications circuitry 208 may transmit the session identifier (based upon the verified authentication credential) to the first user device 102 to authenticate the session. The operations of FIG. 4 may be, for example, performed in response to a request for authentication from the external device 106, such that the session identifier generated at operation 404 is subsequently transmitted to the external device 106 at operation 406.

In some embodiments, as shown in operation 408, the apparatus (e.g., identity server 200) may include means, such as the processor 202, generation circuitry 210, or the like for modifying the previously acquired iteration of the at least one dynamic attribute of the first user stored by the digital identity construct database based upon the at least one determined dynamic attribute. By way of continued example, in some embodiments, the determined dynamic user attribute at operation 306 in FIG. 3 may be dynamic in nature such that the corresponding attribute stored by the digital identity construct database is not identical to the current numerical value for the determined attribute. The identity server 200 may, as part of the variance determinations described hereafter, operate to project, estimate, or otherwise determine this discrepancy at operation 408. In response, the identity server 200 may operate to modify, update, or otherwise adjust the digital identity construct database to account for any variance associated with a dynamic user attribute. In doing so, the identity server 200 may operate to iteratively improve the digital identity construct database while also ensuring accurate and consistent authentication for the first user with subsequent requests for authentication.

Turning next to FIG. 5, a flowchart is shown for credential variability determinations. The operations illustrated in FIG. 5 may, for example, be performed by, with the assistance of, and/or under the control of an apparatus (e.g., identity server 200), as described above. In this regard, performance of the operations may invoke one or more of processor 202, memory 204, input/output circuitry 206, communications circuitry 208, generation circuitry 210, and/or sensing circuitry 212.

With reference to operation 502, the apparatus (e.g., identity server 200) includes means, such as processor 202 or the like, for determining a variability between the inquiry authentication credential and the verified authentication credential. As described above with reference to FIG. 3, the inquiry authentication credential and the verified authentication credential may each comprise numerical representations generated or obtained based upon respective static and dynamic attributes. As such, a variance may be determined at operation 502 that is based upon the similarity between these numerical values. For example, the variability or variance may be determined as a percentage difference, numerical difference, Euclidean distance between points plotted based upon the inquiry authentication credential and the verified authentication credential, and/or the like. Furthermore, the present disclosure contemplates that various attributes may be weighted based upon the, for example, assurance associated with the request for authentication. By way of a nonlimiting example, the variance or variability determined at operation 502 may be a percentage difference of 5%.

With reference to operation 504, the apparatus (e.g., identity server 200) includes means, such as processor 202 or the like, for comparing the variability with a variability threshold. The identity server 200 may employ a plurality of variability thresholds that may be, for example, based upon the type or amount of user attributes used in generating the inquiry and verified authentication credentials. For example, as the complexity of the attribute and the amount of the attributes increases, the required similarity as defined by the variability threshold may decrease. By way of example, the variability threshold at operation 504 may define a threshold of 10% such that the example percentage difference of 5% determined at operation 502 satisfies the variability threshold. Said differently, the comparison at operation 504 may, in an instance in which the percentage difference (e.g., variability or variance) determined at operation 502 is less than the maximum allowed percentage difference (e.g., variability threshold), indicate that the inquiry authentication credential is sufficiently similar to the verified authentic credential.

In such an instance, as shown in operation 510, the apparatus (e.g., identity server 200) may further include means, such as the processor 202, generation circuitry 210, or the like for authenticating the first user as described above with reference to operation 314. In an instance in which the variability fails to satisfy the variability threshold, such as an instance in which the percentage difference exceeds the maximum percentage difference defined by the threshold, the apparatus, (e.g., identity server 200), as shown in operation 512, may further include means, such as the processor 202, communications circuitry 208, or the like for generating a failure notification. Such a failure notification may be transmitted to, for example, the first user device 102 and/or the external device 106 (e.g., the device requesting authentication). Such a notification may, in some embodiments, comprise instructions for iteratively performing the operations of FIG. 3 by determining different user attributes or may, alternatively, indicate a fraudulent attempt by an unauthorized user to establish a session as the first user.

In some embodiments, as shown in operation 506 and 508, the apparatus (e.g., identity server 200) may further include means, such as the processor 202, generation circuitry 210, or the like for comparing the variability with a modification threshold and modifying the previously acquired iteration of the at least one dynamic attribute of the first user stored by the digital identity construct database in an instance in which the variability satisfies the modification threshold. By way of example, in some embodiments, a tiered threshold technique may be used to determine if the person (e.g., first user) requesting authentication is the first user (e.g., based upon user attribute comparisons as described herein) and further determine if the attribute of the user (e.g., dynamic attributes) have sufficiently changed to require updating of the digital identity construct database. For example, the modification threshold may define a percentage change value of 5% indicating that the percentage difference (e.g., variance or variability) between the inquiry authentication credentials and the verified authentication credentials must not exceed 5%. In an instance in which the variability satisfies this modification threshold (e.g., a percentage difference of 1% or the like), no further updates to the digital identity construct database may be necessary as the determined dynamic attribute and the previously acquired iteration of the determined dynamic attribute are sufficiently similar. In an instance in which the variability fails to satisfy this modification threshold (e.g., a percentage difference of 7% or the like), the identity server 200 may update at least the dynamic attribute of the first user stored by the digital identity construct database to reflect the dynamic or evolving nature of this attribute.

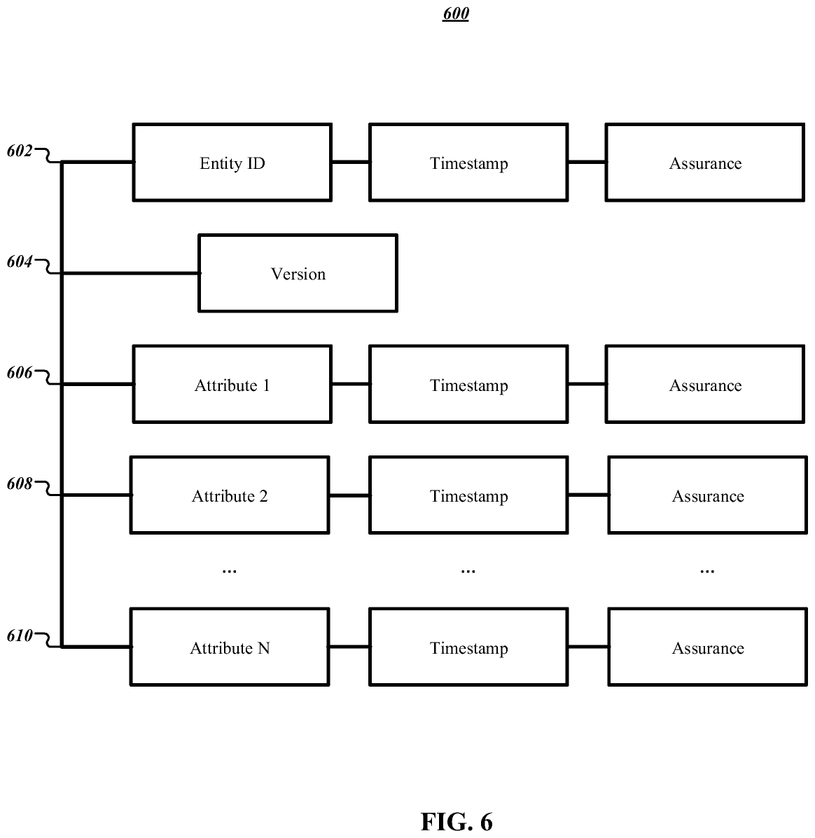

With reference to FIG. 6, a visual representation of an example digital identity construct configuration 600 (e.g., an example representation of one potential version of the digital identity construct database 110) is shown. By way of a non-limiting example, the digital identity construct database 110 may be formed of a record header 602 that includes an entity identifier or identification, for example, a identifier associated with the first user and/or first user device 102. In some embodiments, the entity identifier (ID) may include propriety values or object identifiers (OID) and/or be registered with the Internet Assigned Numbers Authority (IANA). The record header 602 may further include a timestamp or time value associated with the version 604 of the digital identity construct database 600 that may, for example, represent the time at which the digital identity construct database 600 is accessed, updated, or the like. In some instances, the timestamp entry in the record header 602 may include a cumulative representation of the timestamp values associated with each attribute stored by the digital identity construct database 600. The record header may further include an assurance entry that is indicative of the cumulative assurance associated with attributes stored by the digital identity construct database 600 as described hereafter.

The example digital identity construct database 600 may include a plurality of user attribute (e.g., entity attribute) entries 606, 608, 610 associated with a first attribute, a second attribute, . . . , and an N^{th} attribute. The first attribute entry 606 may include an associated timestamp indicative of the time at which the first attribute was received by the digital identity construct database 600. In some embodiments, this timestamp may instead refer to the time at which the first attribute entry 606 was generated. The first attribute entry 606 may further include an associated assurance or weight associated with the first attribute entry 606. As described above, the assurance may refer to a confidence associated with the first attribute entry 606. Similarly, the second first attribute entry 608 and the N^{th} attribute entry 610 may include an associated timestamp indicative of the time at which the second attribute and the N^{th} attribute, respectively, were received by the digital identity construct database 600. As above, in some embodiments, this timestamp may instead refer to the time at which the second attribute entry 608 and N^{th} attribute entry 610, respectively, were generated. The second attribute entry 608 and the N^{th} attribute entry may further include an associated assurance or weight associated with the second attribute entry 608 and the N^{th} attribute entry 610, respectively. As described above, the present disclosure contemplates that the example digital identity construct database 600 may include any number of user attributes without limitation. Furthermore, the timestamp value for various attribute entries may vary (e.g., a current version of the database 600 may have today's date but one application entry may have a timestamp that is a week/a month old). Each request for authentication may accept or reject attribute entries based upon, for example, the timestamp and/or assurance associated with each attribute entry.

As described above, various technical challenges are surmounted via technical solutions contemplated herein. For example, embodiments of the disclosure may operate to address several technical challenges including providing a mechanism for real time authentication based upon evolving user attributes. Said differently, some embodiments described herein may detect the available user attribute data (e.g., as defined by applicable sensing devices or the like) and modify attribute selection based upon the same. Furthermore, these embodiments may provide a mechanism for vary attribute security based upon the assurance associated with a particular interaction. For example, the request for authentication received by the system may determine a variable assurance level associated with the interaction (e.g., an increased assurance associated with large value transactions, an increased assurance associated with particularly vulnerable or sensitive user data, etc.) and modify the amount or type of user attributes selected.

FIGS. 3-5 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the identity server 200 and executed by a processor 202 of the identity server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### Conclusion

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The invention claimed is:

1. A computer-implemented method for digital identity based authentication, the method comprising:
receiving a request for authentication associated with a first user;
determining attributes associated with the first user, wherein the attributes comprise:
at least one static attribute, wherein static attributes comprises attributes of the first user that remain constant over time; and/or
at least one dynamic attribute, wherein dynamic attributes comprises attributes of the first user that vary over time;
generating an inquiry authentication credential based upon the at least one static attribute and the at least one dynamic attribute determined for the first user;
querying a digital identity construct database storing one or more previously acquired attributes of the first user, wherein the digital identity construct database comprises at least one previously acquired iteration of the at least one determined static attribute and at least one previously acquired iteration of the at least one determined dynamic attribute of the first user;
obtaining a verified authentication credential based upon the previously acquired iteration of the at least one determined static attribute of the first user and the previously acquired iteration of the at least one determined dynamic attribute of the first user; and
authenticating the first user based upon a comparison between the inquiry authentication credential and the verified authentication credential.

2. The computer-implemented method according to claim 1, wherein the request for authentication further comprises an instruction to generate a session identifier from a first user device associated with the first user, the method further comprising:
generating the session identifier based upon the verified authentication credential; and
transmitting the session identifier to the first user device.

3. The computer-implemented method according to claim 1, further comprising modifying the previously acquired iteration of the at least one dynamic attribute of the first user stored by the digital identity construct database based upon the at least one determined dynamic attribute.

4. The computer-implemented method according to claim 1, wherein determining attributes associated with the first user further comprises:
receiving sensor data from a first user device associated with the first user; and
determining one of the at least one static attribute or the at least one dynamic attribute of the first user based upon the sensor data.

5. The computer-implemented method according to claim 1, wherein authenticating the first user further comprises:
determining a variability between the inquiry authentication credential and the verified authentication credential;
comparing the variability with a variability threshold; and
authenticating the first user in an instance in which the determined variability satisfies the variability threshold.

6. The computer-implemented method according to claim 5, wherein authenticating the first user further comprises:
comparing the variability with a modification threshold; and
modifying the previously acquired iteration of the at least one dynamic attribute of the first user stored by the digital identity construct database in an instance in which the variability satisfies the modification threshold.

7. The computer-implemented method according to claim 1, wherein determining attributes associated with the first user further comprises:
determining an assurance requirement associated with the request for authentication; and
modifying one or more of an amount of attributes associated with the first user or a type of attributes associated with the first user.

8. An apparatus for digital identity based authentication comprising at least one processor and at least one memory, the at least one memory having computer-code instructed stored thereon that, in execution with the at least one processor, configure the apparatus to:
receive a request for authentication associated with a first user;
determine attributes associated with the first user, wherein the attributes comprise:
at least one static attribute, wherein static attributes comprises attributes of the first user that remain constant over time; and/or
at least one dynamic attribute, wherein dynamic attributes comprises attributes of the first user that vary over time;
generate an inquiry authentication credential based upon the at least one static attribute and the at least one dynamic attribute determined for the first user;
query a digital identity construct database storing one or more previously acquired attributes of the first user, wherein the digital identity construct database comprises at least one previously acquired iteration of the at least one determined static attribute and at least one previously acquired iteration of the at least one determined dynamic attribute of the first user;
obtain a verified authentication credential based upon the previously acquired iteration of the at least one determined static attribute of the first user and the previously acquired iteration of the at least one determined dynamic attribute of the first user; and
authenticate the first user based upon a comparison between the inquiry authentication credential and the verified authentication credential.

9. The apparatus according to claim 8, wherein the request for authentication further comprises an instruction to generate a session identifier from a first user device associated with the first user, the apparatus further configured to:
generate the session identifier based upon the verified authentication credential; and
transmit the session identifier to the first user device.

10. The apparatus according to claim 8, further configured to modify the previously acquired iteration of the at least one dynamic attribute of the first user stored by the digital identity construct database based upon the at least one determined dynamic attribute.

11. The apparatus according to claim 8, wherein, in determining attributes associated with the first user, is further configured to:
receive sensor data from a first user device associated with the first user; and
determine one of the at least one static attribute or the at least one dynamic attribute of the first user based upon the sensor data.

12. The apparatus according to claim 8, wherein, in authenticating the first user, the apparatus is further configured to:
determine a variability between the inquiry authentication credential and the verified authentication credential;
compare the variability with a variability threshold; and
authenticate the first user in an instance in which the determined variability satisfies the variability threshold.

13. The apparatus according to claim 12, wherein, in authenticating the first user, the apparatus is further configured to:
compare the variability with a modification threshold; and
modify the previously acquired iteration of the at least one dynamic attribute of the first user stored by the digital identity construct database in an instance in which the variability satisfies the modification threshold.

14. The apparatus according to claim 8, wherein, in determining attributes associated with the first user, the apparatus is further configured to:
determine an assurance requirement associated with the request for authentication; and
modify one or more of an amount of attributes associated with the first user or a type of attributes associated with the first user.

15. A computer program product for digital identity based authentication comprising at least one non-transitory computer-readable storage medium having computer program code thereon that, in execution with at least one processor, configures the computer program product for:
receiving a request for authentication associated with a first user;
determining attributes associated with the first user, wherein the attributes comprise:
at least one static attribute, wherein static attributes comprises attributes of the first user that remain constant over time; and/or
at least one dynamic attribute, wherein dynamic attributes comprises attributes of the first user that vary over time;
generating an inquiry authentication credential based upon the at least one static attribute and the at least one dynamic attribute determined for the first user;
querying a digital identity construct database storing one or more previously acquired attributes of the first user, wherein the digital identity construct database comprises at least one previously acquired iteration of the at least one determined static attribute and at least one previously acquired iteration of the at least one determined dynamic attribute of the first user;
obtaining a verified authentication credential based upon the previously acquired iteration of the at least one determined static attribute of the first user and the previously acquired iteration of the at least one determined dynamic attribute of the first user; and
authenticating the first user based upon a comparison between the inquiry authentication credential and the verified authentication credential.

16. The computer program product according to claim 15, wherein the request for authentication further comprises an instruction to generate a session identifier from a first user device associated with the first user, the computer program product further configured for:
generating the session identifier based upon the verified authentication credential; and
transmitting the session identifier to the first user device.

17. The computer program product according to claim 15, further comprising modifying the previously acquired iteration of the at least one dynamic attribute of the first user stored by the digital identity construct database based upon the at least one determined dynamic attribute.

18. The computer program product according to claim 15, wherein, in determining attributes associated with the first user, the computer program product further configured for:
receiving sensor data from a first user device associated with the first user; and
determining one of the at least one static attribute or the at least one dynamic attribute of the first user based upon the sensor data.

19. The computer program product according to claim 15, wherein, in authenticating the first user, the computer program product further configured for:
determining a variability between the inquiry authentication credential and the verified authentication credential;
comparing the variability with a variability threshold; and
authenticating the first user in an instance in which the determined variability satisfies the variability threshold.

20. The computer program product according to claim 15, wherein, in determining attributes associated with the first user, the computer program product further configured for:
determining an assurance requirement associated with the request for authentication; and
modifying one or more of an amount of attributes associated with the first user or a type of attributes associated with the first user.
